(19) United States
(12) Patent Application Publication
(10) Pub. No.: US 2005/0129243 A1
(43) Pub. Date: Jun. 16, 2005

(54) Encryption key hiding and recovering method and system

(75) Inventor: Laurent Pierre Francois Bousis, Leuven (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/507,775

(22) PCT Filed: Feb. 19, 2003
(86) PCT No.: PCT/IB03/00728

(30) Foreign Application Priority Data
Mar. 20, 2002 (EP) 02076089.8

(51) Int. Cl. H04L 9/00

(52) U.S. Cl. 380/277

(57) ABSTRACT

An encrypted data-encryption key is hidden in the random header of a message exchanged between two parties according to a shared function known by both parties A checksum of the modified random header is thereafter appended.

### BACKGROUND OF THE INVENTION

The invention relates to a method for data encrypting through generating on the basis of a particular data exchange from a sequence of such data exchanges a respective random encryption key as has furthermore been recited in the preamble of claim 1. The data exchange can relate to storage followed by delayed reading, or by a transmission, such possibly including broadcast, to a recipient party. Upon reading or receiving the data, first the encrypted random key will be decrypted using the shared key, followed by decrypting the data proper through the retrieved random encryption key. This method will raise the level of security inasmuch as the amount of ciphertext associated to a particular key will be restricted to only the size of one random key, which will render a codebreaker's problems, such as met when undertaking a brute force attack on the encrypted random key, ever so much greater. In fact, outside the encrypted key the data will be truly random, instead of having at least some form of correlation, such as being represented by the format of the file.

Nevertheless, the present inventor has recognized a need for a still higher degree of safety, in that such codebreaker should not be able to immediately point to the occurrence in time and/or space of the encrypted random key, but should be left uncertain as to the location of such occurrence.

### SUMMARY TO THE INVENTION

In consequence, amongst other things, it is an object of the present invention to hide as it were the encrypted random key, so that an attacker would not know where to look for the immediate target to attack, whilst nevertheless letting the intended recipient of the data find the location of the key in question with appropriate ease.

Now therefore, according to one of its aspects the invention is characterized according to the characterizing part of claim 1.

In particular, the encrypted key will be hidden in a header of the data exchange in question. Various reasons would render it advantageous to use the header instead of the data itself. The principle of the present invention will in fact be easier to implement with constrained devices both during encrypting and during decrypting. In the encrypting, the encoding generates a string of random data and replaces the part thereof that is selected through the hide function, by the bits of the encrypted random key. Such approach distinguishes from inserting the encrypted random key before or behind the bits from the data file that are selected by the hide function. The latter procedure could in fact require the providing of appreciably large buffers to let the data file make room for the encrypted random key. Note that the header principle should not be construed to represent a header according to some pre-existent standard for transmission or storage. In this context, the header means some part “at or near the beginning of the data exchange”.

Furthermore, in the decrypting the block cipher will most probably be used in a feedback mode. Now, the inserting of the encrypted random key in the data will change the alignment of the cipher block. Next to the encrypted data, certain blocks would additionally have bits from the encrypted random key. During decryption, care would be necessary to skip the bits of the encrypted random key. This aspect could have added further processing overhead and/or necessary memory space. In both situations, the processing architecture is simplified through the replacing embodiment of the present invention.

Another argument for hiding the encrypted random key in the header is that such would raise of the security level. In fact, a hacker could find out a size difference between the plaintext data file and the encrypted data file, and conclude that the key has therefore been hidden by adding the key to the file. A subsequent attack step would then be to feed a very small data file to the writing/encoding system. Now, the probability of hitting at a particular bit location in the encrypted file a bit from the encrypted random key itself would be Nr/Nd, wherein Nr is the random part and Nd the overall size; with the above approach, the value of the quotient would approach unity. In contradistinction, the hiding of the key within the random matter proper will keep this probability down to Nr/(Nh+Nd). The value of this quotient may be substantially lower than one, such depending on the number of random matter bits that have been added to the file (Nh).

The invention also relates to a device arranged for implementing such method for encrypting, to a method and device for decrypting the result of such encrypting, to a system arranged for executing both the encrypting and also the decrypting, and to a tangible medium or signal encompassing such encrypted data Further advantageous aspects of the invention are recited in dependent claims.

### BRIEF DESCRIPTION OF THE DRAWING

These and further aspects and advantages of the invention will be discussed more in detail hereinafter with reference to the disclosure of preferred embodiments, and in particular with reference to the appended Figures that show the following, and wherein corresponding items are carrying identical numerals:

FIG. 1, a data encryption scheme through use of a shared secret key;

FIG. 2, an encryption scheme that uses a shared secret key for therewith encrypting random encryption keys;

FIG. 3, the use of a shared key for encrypting random keys followed by hiding the encrypted random keys;

FIG. 4, an embodiment for actually hiding the encrypted random keys;

FIG. 5, an encrypting calculation detail pertaining to the embodiment of FIG. 4; FIG. 6, an embodiment for actually retrieving the encrypted random keys;

FIG. 7, a retrieving calculation detail pertaining to the embodiment of FIG. 6;

FIG. 8, a comprehensive system using the security enhancing measures of the present invention.

### DETAILED DESCRIPTION OF PREFERRED EMBODIMENTS

FIG. 1 illustrates a prior art data encryption scheme through a shared secret key. At left, the writing or transmitting takes place, at right the reading or receiving. Through using a shared secret key (24), the input data (20) are effectively encrypted (22) and subsequently written (26) on a medium (28). The medium may be various, such as a CD-recordable, ZIP, Flash Memory, a transmission line or a broadcast organization. The disclosure hereinafter will abstract from physical realization such as optically readable, data coding such as NRZ, EFM, and others, and also from other OSI layers such as the formatting of a message or record. For use of the data, first the medium (28) is read (30), and thereafter the data are decrypted (32) using the shared secret key (24) to allow presenting the data (36). In principle, data 20 and 36 can be identical. The disclosure hereinafter will generally abstract from the encrypting algorithm proper, such as DES, RSA, or other. The distribution of the secret key has been considered granted.

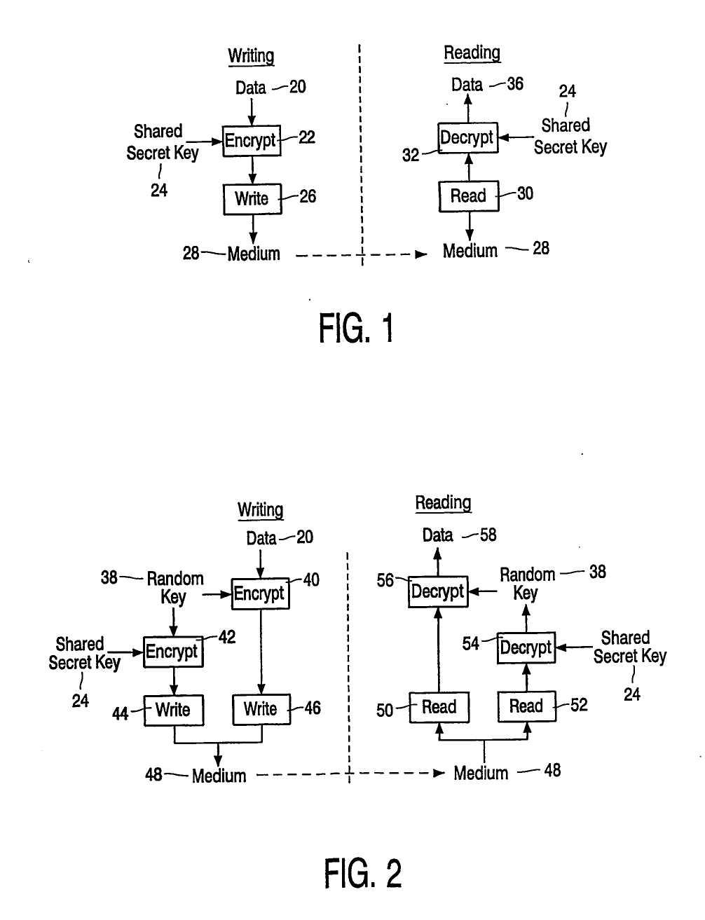

FIG. 2 illustrates an improved encryption scheme that uses a shared secret key for encrypting random keys, wherein these random keys are used to encrypt the data proper. Now, both the encrypted data and also the encrypted random keys will be stored on the medium. In FIG. 2, the random key (38) is generated by an appropriate random or pseudo-random procedure and used to encrypt (40) the data (20), and is then also encrypted itself (42) through using the shared secret key (24). Thereafter both encrypted entities are written (44, 46) to the medium (48). For the using of the data, first the medium (48) is read (50, 52), after which the shared key (24) is used to decrypt (54) the actual random key (38), that in its turn is used to decrypt (56) the data proper (58).

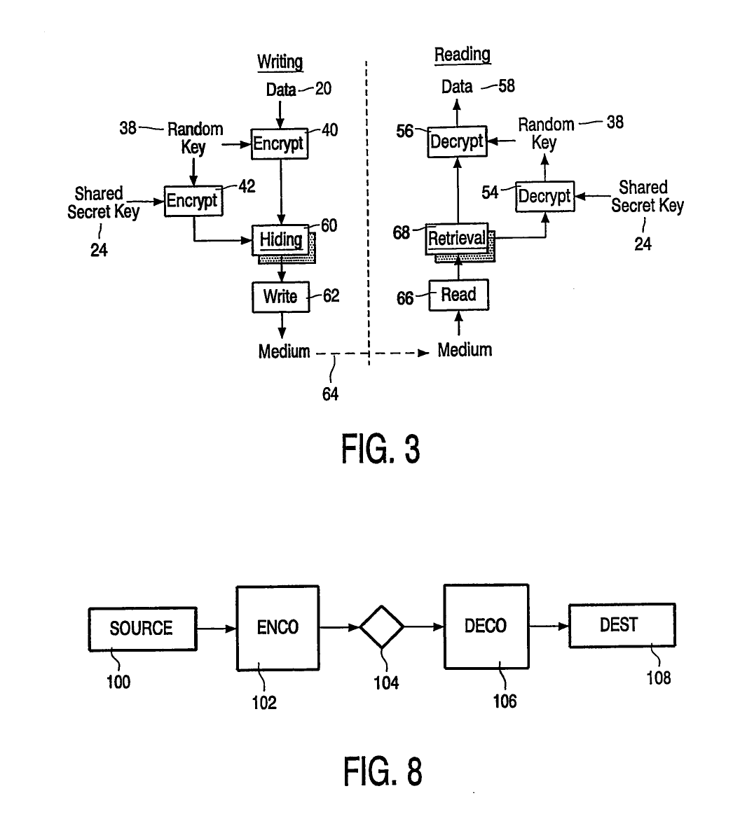

Now, the present invention consists in further raising the security by hiding the encrypted random key on the physical medium or in the exchange signal in a novel way, and for further reducing the amount of ciphertext that will effectively be available for cryptanalysis to none at all. In this respect, FIG. 3 illustrates the use of a shared key for encrypting random keys followed by hiding thereof. Whereas many of the items in FIG. 3 correspond to those of FIG. 2, the encrypted random key is being hidden (60) in association with the encrypted data to which the key in question pertains, after which the combination is written (62) on the medium (64). For use of the data, the medium (64) is read (66), whereupon the hidden encrypted random key is first retrieved (68) and then decrypted (54) as in FIG. 2. Thereafter, the data is decrypted in its turn.

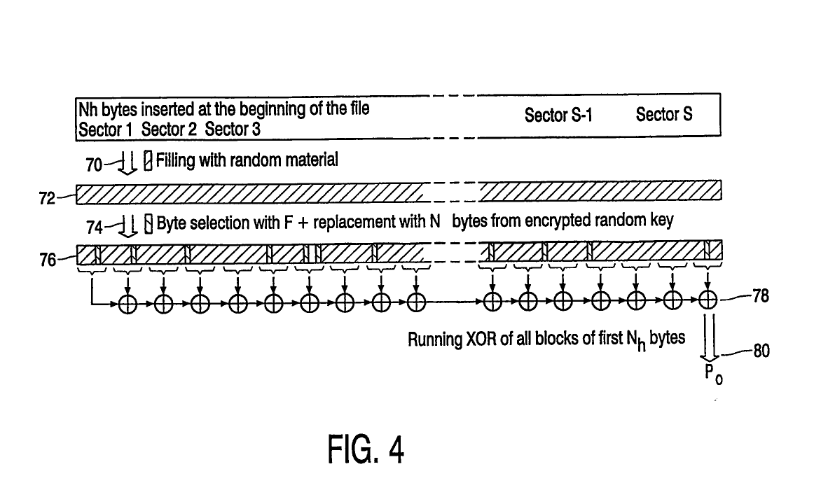

In this respect, FIG. 4 illustrates an embodiment for actually hiding the encrypted random keys. Particularly, the method consists in putting both the encrypted data and the encrypted random key in the same file. This is done by inserting as shown by hatching a number of Nh bytes of random material at the beginning of the file, and appending the Nd bytes of encrypted data after those Nh bytes. The complete file is thus Nh+Nd bytes. The size of Nh is directly proportional to the size of the encrypted random key Nr and furthermore, the size of Nh must also be an integer multiple of the blocksize of the symmetric block encryption algorithm that is used. The effective security will furthermore increase with the value of the ration Nh/Nr.

Now, once the first Nh bytes of the file have been filled with random matter, a shared function F that is known by both transmitting and receiving systems is called to be used for writing the data on the medium. This function will then return a selection of Nr bytes from the Nb bytes of random material. For each of the returned bytes, the random material will be replaced by consecutive bytes from the encrypted random key as shown by counterhatching. Once all returned bytes will have been processed, a running EXOR (exclusive OR) result (P0, 80) of all the blocks from the first Nh bytes of the file will be calculated, as shown (78) at the bottom of FIG. 4.

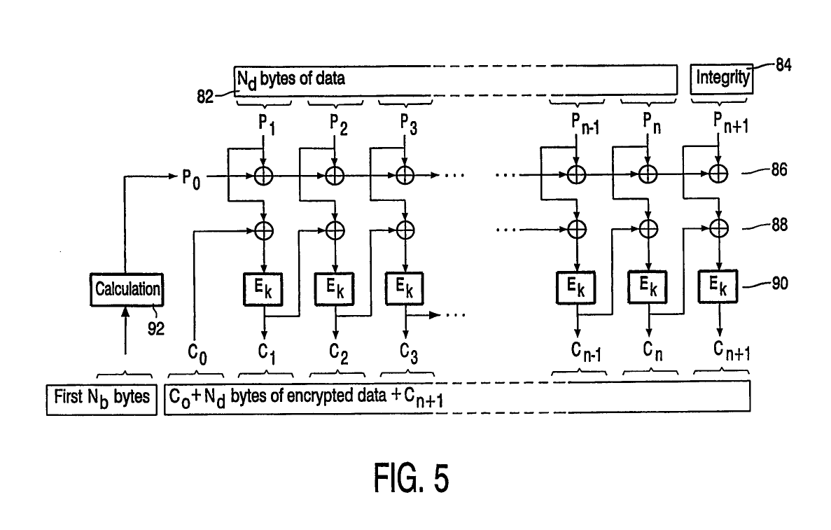

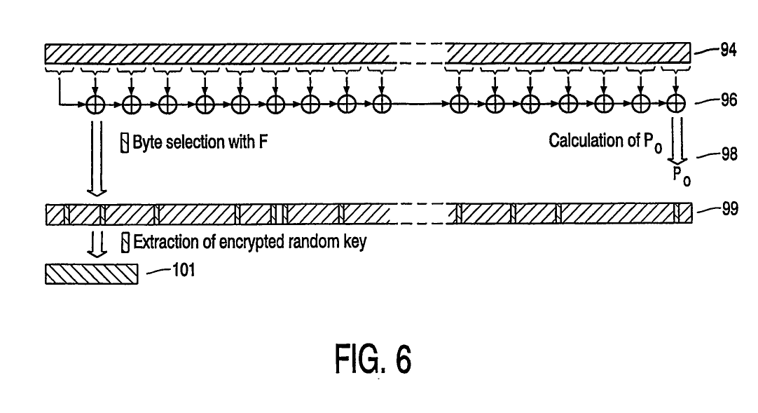

Next, the data (82) are encrypted through using the generated random key in a symmetric block encoding algorithm through Cipher Block Chaining with Checksum mode, such as by itself is prior art, cf. the textbook by Bruce Schneier, Applied Cryptology, pages 207-208, Second Edition, 1996. The technology in question is further improved by starting the running EXOR calculation (86, 88) with the result (P0) of the running EXOR calculation (92) of the blocks of the first Nh bytes of the file, as illustrated in FIG. 5. Herein, like in the other Figures, EXORing has been shown by the standard crossed circle signs indications.

Through the adding of a running EXOR of the random data header as a feed for CBCC encryption of the data, the recipient can make sure that no single bit will have been modified by a hacker. This is necessary to prevent an attack wherein a hacker would only modify one bit of the random data header at a time. If the modified bit of the random material were not selected by the function F, the receiving system would still effectively read the file in question. If on the other hand the modified bit did belong to the encrypted random key, the encrypted data file could not be correctly received, inasmuch as the key to be used for decrytion would not be correct. Therefore, the hacker would be able to discriminate between the encrypted random key and the remaining parts of the random material. Repeating this approach would allow to quickly find out what the function F does, and would thereupon allow to find the bits from the encrypted random key in every further encrypted data file.

FIG. 5 illustrates an encrypting calculation detail pertaining to the embodiment of FIG. 4. Here, C0 is a block of random material used as an initialization factor. The data to be encrypted range from P1 to Pn, wherein Pn+1 is a constant block that operates as an integrity constant. that will be encrypted to Cn+1. Those n+2 bytes will be appended to the first Nh bytes of the file. The block Pn+1 may for example be represented by a succession of bytes with a uniform value 0×25.

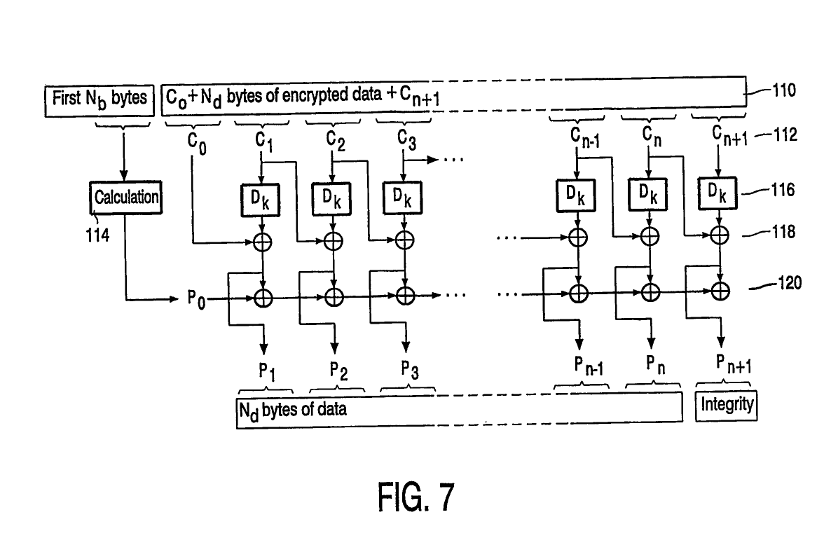

FIG. 6 illustrates an embodiment for actually retrieving the encrypted random keys. For decoding, the shared secret function F will be called by the system that reads the data 94 from the physical medium. This function F, as indicated by counterhatching, will return a selection of Nr bytes from the Nh bytes of the file from which selection the encrypted random key will be retrieved. A running EXOR 96 of all blocks from the first Nh bytes of the file will be calculated to yield (98) the original value P0. The encrypted random key will then be decrypted using the shared secret key and the result thereof will be used to decrypt the data found in the file after the byte Nh through the symmetric block encryption algorithm in the CRCC mode discussed earlier. The latter is modified in that instead of starting the running EXOR with the first block of data, it is only begun with the result of the running EXOR calculation (114, P0) of the blocks of the first Nh bytes of the file. The latter is in particular shown in FIG. 7.

FIG. 7 illustrates a retrieving calculation detail pertaining to the embodiment of FIG. 6. Here, C0 is used directly as an initialization vector. The value of Pn+1 is checked to determine whether it matches the integrity constant. If it does, this proves that neither the encrypted data file, nor the first Nh bytes of the used to hide the encrypted random key have been tampered with; hence the modification of the CBCC mode and the introduction of P0.

The function F takes as input the number of bytes available for selection (Nh), and the number of bytes to select (Nr). Various definitions of the function F are possible. Here, the following exemplary embodiment is used for F. Take n bits from a random number generator, wherein n is defined as └log(Nh)/log(2)┘. Next, interpret those n bits as the rank number of the byte to select, which rank lies in a range from 0 to Nr. This procedure repeats until Nr different bytes have been selected. This procedure is effective only when both the transmitting and the receiving subsystem share the same secret seed information for the random number generator. If otherwise, both subsystems would have different selections. To further raise the security level, the method uses a seed information that is a combination of the shared secret seed and the number of data bytes Nd and/or the serial number of the physical medium, etcetera, in order to produce a different selection for each file that is being exchanged. As mentioned earlier, the degree in security rises together with the ratio Nh/Nr. Nevertheless, both simpler, and also more sophisticated definitions for F may be used, depending inter alia on the effective processing power. For example, function F can just return every n^{th} byte, wherein n is defined as Nh/Nr.

By distributing the bytes of the encrypted random key over a pool of random material, and appending to this the encrypted material itself, the security of the system is effectively raised, inasmuch as a cryptanalyst cannot know which bytes belong to the random material, to the encrypted data, and to the encrypted random key, respectively, so that no ciphertext is anymore available for analysis. There is a probability of {(Nh+Nd)^{Nr}}⁻¹ of finding the correct ciphertext that is the encrypted random key, by trying byte-combinations, provided that the shared secret (i.e., the shared secret seed) is kept protected indeed. The security in this respect can be further enhanced through changing the resolution from bytes to bits in the hiding procedure for the encrypted random key. Furthermore, the addition of a running EXOR of the first Nh bytes of the file, and the insertion thereof into a modified CBCC mode, enforce integrity at the price of needing only little additional hardware facilities. In particular, not even a hash function is necessary.

FIG. 8 illustrates a system using the security enhancing measures of the present invention. From left to right, the system comprises a data source 100, an encoder apparatus 102 that implements an algorithm for encrypting the source data according to the present invention, a tangible medium 104 for carrying the data encrypted by the apparatus 102, a decrypting apparatus 106 for which the encrypted data on tangible medium 104 operates as source data for decrypting, and a data user facility 108 that uses the data encrypted by apparatus 106 for an application that by itself is irrelevant to the present invention. Regarding a data exchange through a signal not needing a tangible medium, the overall system would be comparable.

1. A method for data encrypting through generating on the basis of a particular data exchange from a sequence of such data exchanges a respective random encryption key, and using furthermore a shared encryption key for encrypting various said random keys for positioning such encrypted random keys in association with the encrypted data,
said method being characterized in hiding such encrypted random key in the data exchange whilst maintaining said association with respect to one or more spatial and/or temporal variables.

2. A method as claimed in claim 1, wherein maintaining said association pertains to storing the encrypted random key in a random header of the data exchange in question.

3. A method as claimed in claim 1, whilst using a symmetric block encryption algorithm.

4. A method as claimed in claim 1, whilst selecting a part of the random header by a hide function and replacing the part selected by bits of the encrypted random.

5. A method as claimed in claim 4, wherein the data is encrypted through using the generated random key in a symmetric block encoding algorithm in Cipher Block Chaining with Checksum mode.

6. A method as claimed in claim 5, whilst executing a running EXOR of all the blocks from the first Nh bytes of the file.

7. A method as claimed in claim 6, whilst furthermore raising the security level by using a seed information that is a combination of the shared secret key and the number of data bytes Nd.

8. A method as claimed in claim 1, whilst furthermore applying an integrity check constant (Pn+1) through EXORING to the data bytes and header bytes.

9. A method as claimed in claim 1, whilst furthermore defining the hide function F according to n=└log(Nh)/log(2)┘, wherein n are bits from a random number, thereby indicating the rank of a byte to select, until a sufficient number of different bytes have been found for being replaced.

10. An apparatus being arranged for data encryption through implementing a method as claimed in claim 1, said apparatus comprising generating means for generating on the basis of a particular data exchange of a sequence of such data exchanges a respective random encryption key, encryption means fed by said generating means for, through furthermore using a shared encryption key, encrypting various said random keys, and positioning means for positioning such encrypted random keys in association with the encrypted data,
said apparatus being characterized by comprising hiding means for hiding such encrypted random key in the data exchange whilst maintaining said association with respect to one or more spatial and/or temporal variables.

11. A method for decrypting data that have been encrypted through a method as claimed in claim 1, whilst using on the basis of a particular data exchange of a sequence of such data exchanges a respectively generated random encryption key after decryption thereof, and using furthermore a shared decryption key that is associated to said shared encryption key for decrypting various said random keys whilst deriving such encrypted random keys through an association with the encrypted data,
said method being characterized by extracting from hiding such encrypted random key from considering said association with respect to one or more said spatial and/or temporal variables.

12. An apparatus arranged for data decrypting through using on the basis of a particular data exchange of a sequence of such data exchanges a respectively generated random encryption key, and decryption means being arranged for using furthermore a shared decryption key that is associated to said shared encryption key for decrypting various said random keys through deriving means arranged for deriving such encrypted random keys through an association with the encrypted data,
said apparatus being characterized by extracting means being arranged for extracting from hiding such encrypted random key from the data exchange through considering said association with respect to one or more spatial and/or temporal variables.

13. A system being arranged for data encrypting and decrypting comprising apparatuses according to claims 10 and 12, respectively, via intermediate transfer through a storage and/or transmission medium.

14. A tangible medium or signal encompassing encrypted data as produced through using a method as claimed in claim 1 or by an apparatus as claimed in claim 8 and/or for use as source material for a method as claimed in claim 9 or for an apparatus as claimed in claim 10.
